(19) United States
(12) Patent Application Publication
(10) Pub. No.: US 2008/0253308 A1
(43) Pub. Date: Oct. 16, 2008

(54) Wireless Broadband Licensed Networking System for Local and Wide Area Networking

(75) Inventors: Marvin Ward, Bristow, VA (US); Shant Hovnanian, New York, NY (US); Christopher Vizas, Washington, DC (US)

Correspondence Address: SYNNESTVEDT LECHNER & WOODBRIDGE LLP, P O BOX 592, 112 NASSAU STREET, PRINCETON, NJ, 08542-0592, US

(73) Assignee: SPEEDUS CORP., NEW YORK, NY (US)

(21) Appl. No.: 10/595,504

(22) PCT Filed: Oct. 22, 2004
(86) PCT No.: PCT/US2004/035383

§ 371 Date: Jun. 9, 2008

(30) Foreign Application Priority Data
Oct. 22, 2003 (US) 60513419

(51) Int. Cl. H04B 7/00; H04L 12/56

(52) U.S. Cl. 370/310; 370/389

(57) ABSTRACT

A licensed microwave radio multi-functional broadband system with multiple numbers of installed edge smart wireless hubs. The system provides dynamic, automated selection of transmission types, including Quadrature Amplitude Modulation (QAM), Quadrature Phase Shift Keying (QPSK) and orthogonal frequency division multiplexing (OFDM) for broadcast over point-to-point, point to multipoint and omni-directional antenna arranged in six equal 60° degree arrays. The system also includes an intelligent data IP packet measurement system that dynamically reads and controls the network Quality of Service [QoS] through software. The automated control may include throttling power up and power down to meet changing effects of transmission parameters in substantially real time.

### CROSS-REFERENCE TO APPLICATIONS

This application is related to, and claims priority from U.S. Provisional Patent application No. 60/513,419 on Oct. 22, 2003 by Ward et al. titled “Wireless Broadband Licensed Networking System for Local and Wide Area Networking”, the contents of which are hereby incorporated by reference.

### TECHNICAL FIELD

The present invention relates to broadband wireless networking systems and more particularly to dynamically adjustable wireless transmission systems.

### BACKGROUND ART

The available Radio Frequency (RF) spectrum continues to become increasingly crowded, in part due to the rapidly growing demand for wireless solutions to the “last mile in the loop” distribution problem. Subscribers located in a number of pockets of coverage, particularly certain urban areas, share modest amounts of bandwidth and experience limited bandwidth availability. Moreover, power in the frequencies allocated for point-to-point and point-to-multi-point RF use often has to be reduced to avoid interfering with adjacent frequencies servicing microwave routes and cellular networks.

There is a need for a point-to-point and point-to multi-point RF systems that makes better use of the limited available frequencies, and preferably a system that can operated at power levels that do not interfere with adjacent microwave signal.

### DISCLOSURE OF INVENTION

The licensed microwave radio multi-functional broadband system of this invention overcomes the above identified disadvantages by providing a dynamic central-to-remote management system and multiple edge smart wireless hubs. Phase Shift Keying (QPSK) and Orthogonal Frequency Division Multiplexing (OFDM) allowing frequency reuse. In a preferred embodiment, the system also automatically selects between point-to-point antennas, point-to-multipoint antennas arranged in typically six equal 60° degree sectors, and an omni-directional broadcast antenna The system of this invention also includes an intelligent data IP packet measurement system that dynamically determines and controls the network Quality of Service [QoS] through software. The automated control may include throttling power up and power down to meet changing effects of transmission parameters in substantially real time.

In a preferred embodiment, the transmitting antenna system has as many as six orthogonal sector antennas for radiating RF signals, as well as point-to-point parabolic antennas and an omni-directional broadcast antenna. Furthermore, the system is capable of automatically receiving and transmitting at least three types of modulated signal types, namely QAM, QPSK, and OFDM, to optimize transmission based on parameters such as path distance, bandwidth, and quality of service [QoS] in point-to-point and point-to-multipoint RF links.

In a preferred embodiment, the system also has one or more remote smart edge wireless hub capable of receiving and transmitting the preferred signal types, namely QAM, QPSK, and OFDM modulated signals. The remote smart edge wireless hub antenna system is also capable of adjusting polarizations orthogonally to achieve minimum crosstalk and maximum isolation from adjacent frequency interferences, and may also transmit and receives RF signals over different path and carrier frequency to establish two or more RF paths.

In a preferred embodiment of the invention, each RF transmitting and receiving channel is coupled to a payload Internet Protocol (IP) switch. The microcontroller associated with the pro-band core microwave radio contains the lookup file database and uses it to maintain strict control of the network, the IP payload data, and the smart edge wireless hubs.

The system provides for a variety of one-way and two-way communications services, including connectivity to Wi-Fi access points, private and public Internet access, IP video streaming, and voice using internet protocol (VoIP) and emergency or public services channels. Dynamic bandwidth control is employed along with very fast payload switch routing using quality of service (QoS) monitoring and selection circuitry. Using fast packet switching, the system has the ability to select the error encoding algorithm, RF path route diversity, polarization, frequency diversity and modulation type, to achieve a desired QoS requirement, which it can measure and verify. The systems user roaming channel is always on hot and ready to respond by accepting a user request for broadband service, as a user jumps on and off at will controlled through a pre-registered access user authentication code lookup file that automatically identifies the user upon its first entry when logging onto the system at any point in the network.

The smart edge hub controller allows pro-band users to request and dynamically change a destination address and bandwidth requirements per user needs in virtually real time from Data Grid Gateways. The Data Grid Gateway setup provides bandwidth and destination information of the requesting subscriber. The user can enter or exit at will. The data packet destination cell carries at all times, an authorization key code that is pre-assigned and opens an available RF channel embedded in assigned radio bandwidth and transmission frequency.

### BRIEF DESCRIPTION OF DRAWINGS

FIG. 1 represents a core-radio transmitting and receiving to smart edge wireless hubs according to the preferred embodiment of the invention making up one data grid.

FIG. 2 represents an exemplary embodiment of the invention comprising six transmit and six receives RF paths representing transmitted signals sent out and received from six smart edge wireless hub sites through six antenna sectors.

FIG. 3 represents an exemplary embodiment of the invention in which an RF ring architecture is formed from the pro-band core microwave radio RF path and smart edge wireless hubs on one of two available polarizations and RF paths.

FIG. 4 is a plan view showing two clusters of pro-band core microwave radios internetworking horizontal and vertical polarizations in order to maintain the desired QoS performance.

FIG. 5 illustrates reuse of four frequencies in six-sectors.

FIG. 6 represents a data grid gateway with four edge smart wireless hubs demonstrating typical polarization configuration for frequency reuse in one cluster of four smart edge wireless hubs.

FIG. 7 illustrates pro-band core microwave connectivity for setting up roaming channels, emergency public channels routing between edge smart hubs and routing through a matrix over RF paths forming dual channel seamless paths.

FIG. 8 is a block diagram of one pro-band core microwave radio that using three modulation and encoding methods selected through IP switch based on user requirements.

FIG. 9 is a block diagram of one pro-band core microwave radio implementing orthogonal frequency division modulation with signal management and flow configured as illustrated in FIG. 8.

FIG. 10 represents a further embodiment of the present invention.

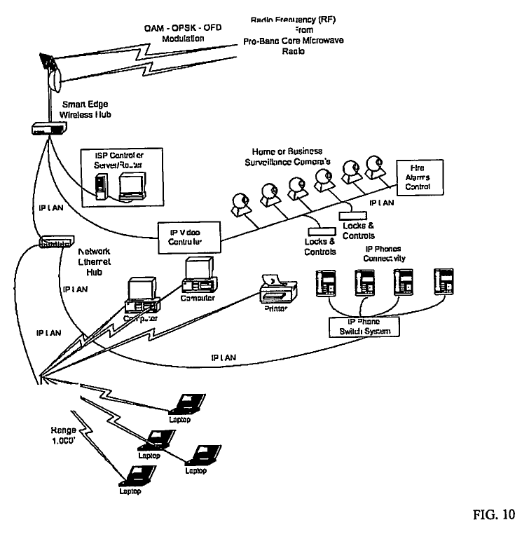

### BEST MODE FOR CARRYING OUT THE INVENTION

During the course of this description like numbers will, as far as possible, be used to identify like elements according to the different figures, which illustrate the invention.

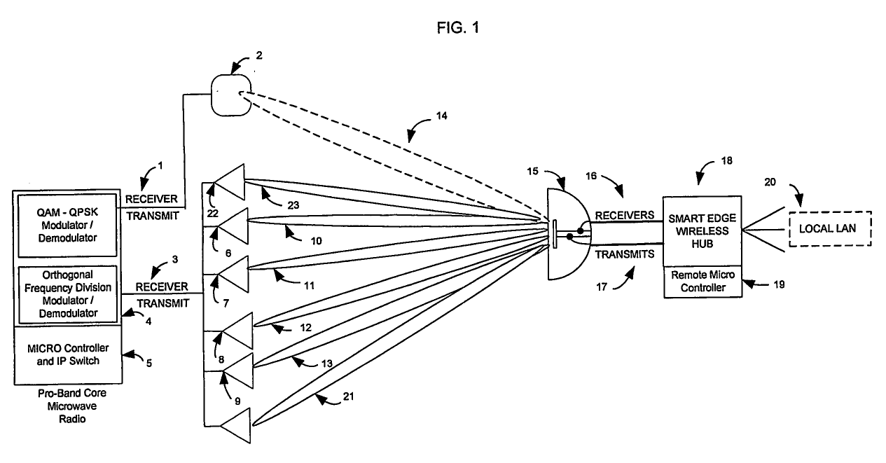

To understand the invention it is easiest to focus on the smallest common element, namely, the single data grid comprising a pro-band core microwave radio and system core-micro-controller and internet protocol (IP) switch and a smart edge wireless hubs, as illustrated in FIG. 1. Together, the pro-band core microwave radio, also known as the core-radio, the core-micro-controller and the IP switch constitute a central processing unit. The connectivity between the data grid elements s through the Orthogonal Frequency Division Multiplexing (OFDM) modem and through the six sector antennas. Although not shown in FIG. 1, the single data grid may comprise a plurality of smart edge wireless hubs. A data grid network is formed from a series of such single data grids.

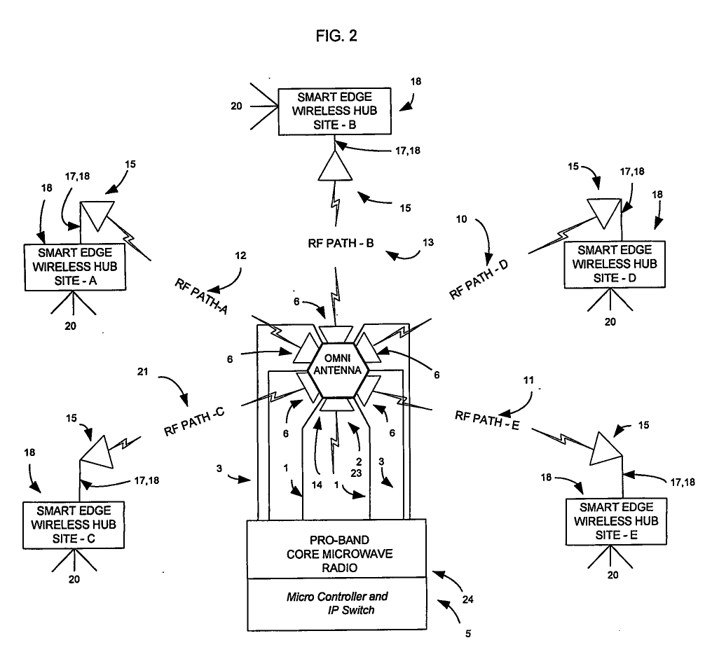

FIG. 2 shows a number of smart edge wireless hubs, initially connected together by transmission and reception parameters that depend upon the pre-login records held in file within the local core-micro-controller. There may as many as hundreds of smart edge wireless hubs, connected through vertical and horizontal polarized signals, with QPSK, QAM and/or OFDM modulation of RF channels directed by the pro-band core microwave and managed by a single core micro controller. This entire embodiment forms one entire data grid network element and for shorter descriptive purposes, is referred herein as a single cluster site. Smart edge wireless hubs may be positioned physically anywhere within the cluster if within RF distance operating range. Operating range is considered satisfactorily if within the cluster site RF operating range with either modulation type applied, desired quality of service (QoS) standards can be met. The smart edge wireless hub communicates via RF transmission. FIG. 1 illustrates only a single RF channel directed to one smart edge wireless hub channel. FIG. 2 illustrates a number of smart edge wireless hubs communicating with the pro-band radio over many RF channels.

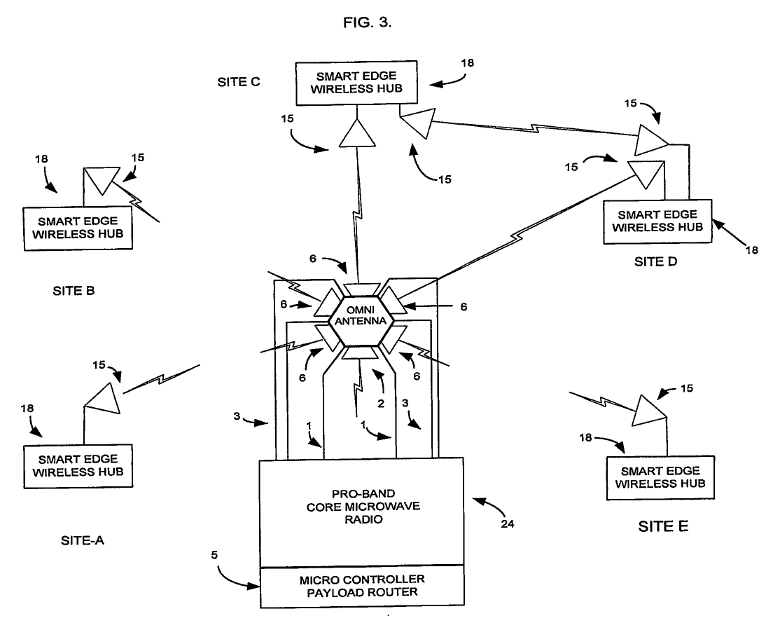

FIG. 3 further illustrates communication between two smart edge wireless hubs over RF channels.

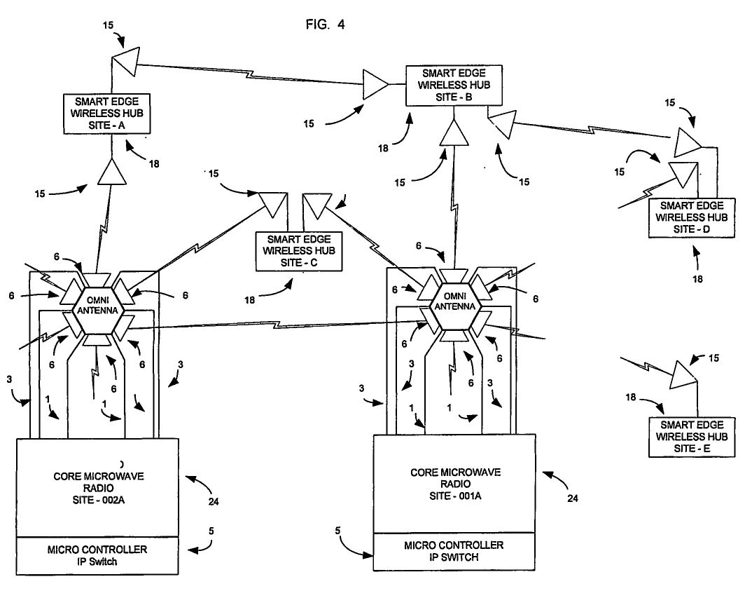

A block diagram schematic of a preferred embodiment of the transmitters and receivers is illustrated in FIG. 4. Four transmitters are at the omni directional radiating node of a group of cells arranged in a geographical array. A digital four channel multiplexer housed as a part of the pro-band core microwave radio frequency reuse plan, provides up to four data streams having digital modulation and connected to the antenna array where each radiate RF signals towards multiples of smart edge wireless hubs situated in various positions within the six sectors of the antenna array path. Each of the antenna arrays are fed OFDM signals with digital modulated content sent over each one of the antennas that form part of typically six radiating sectors.

The signals arrive at the receiving smart edge wireless hub antenna and, depending upon the modulation scheme selected, each signal can be selected remotely by the pro-band core microwave radio core microcontroller, depending upon the quality of service (QoS) received in both directions of transmission. Typical performance includes the two operating modulation schemes depending upon distance between the smart edge wireless hub and pro-band core microwave radio, is selectable by the core microcontroller.

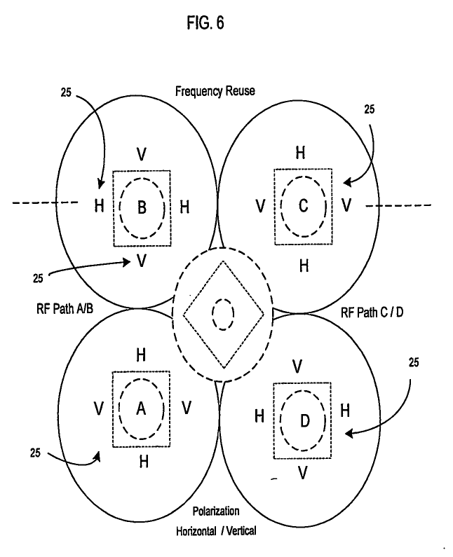

When a smart edge wireless hub is placed in service a relative short distance from the pro-band core microwave radio, the signal is typically selected to have QAM or QPSK modulation so as to provide maximum possible payload transfer (bandwidth). A smart edge wireless hub located a longer distance from the core-radio would, however, operate using yet another modulation and encoding type that has and extended range but may have less bandwidth availability such as, but not limited to, OFDM. Refer to FIG. 6, the transmitting antenna array provides a four cluster polarization arrangement for radiating RF signals with digital coded data sent out upon initial tun-up for testing the RF path under program control of the core microcontroller in the pro-band core microwave radio. This polarization arrangement allows the reuse of frequencies in adjacent channels within the same cluster. The received RF coded signal is analyzed in one direction only; transmission of RF signal from the pro-band core microwave radio, using all four RF signal types are tested and logged in memory for future QoS comparison and reference. Specific operating parameters can impinge on the RF signal; degraded weather can change an RF signal quality and reference causing even another modulation format to be selected. Path analysis is performed during initial turn-up and through automatic selection of different reduced power; settings with modulation types and polarization choices can take place in milliseconds without loss of signal. Transmitted RF signals received from more than one source may undergo RF signal variances in quality due to weather or varying distances from the pro-band core microwave radio. However, any intrinsic differentiation between each frequency is usually quite wide and unintentional reception will typically not take place. The pro-band core microcontroller illustrated in FIG. 3 controls the frequencies and power settings for the path between site C and site D even though these are remote links isolated by RF path from the pro-band core microwave controller. In a preferred embodiment, the transmission frequency is selected by reference to a centralized or distributed registrar of all frequencies available to all of the smart edge hubs.

RF signals arriving at site D receiver enter into the smart edge wireless hub reaching a receiver detector where composite signal detection takes place and IP payload content is decoded in the form of IP packet data. After extraction, these packets are aligned according to IP address code carried in the header located within the data formatted packet. Data directed over routes linking sites C, D back to the pro-band core microwave radio are switched automatically, dependent on actual load on each radio path and available bandwidth availability. The incoming signal and resultant retrieved packets all arrive within milliseconds of each other and delay is considered negligible. The QPSK/QAM transmit RF frequencies transmitted to a smart edge wireless hub are never greater than two, one applied to horizontal and a second to vertical polarizations. During the initial RF path setup and testing sequence, the controller will exercise tests of all frequencies and transmission types and log the results in database.

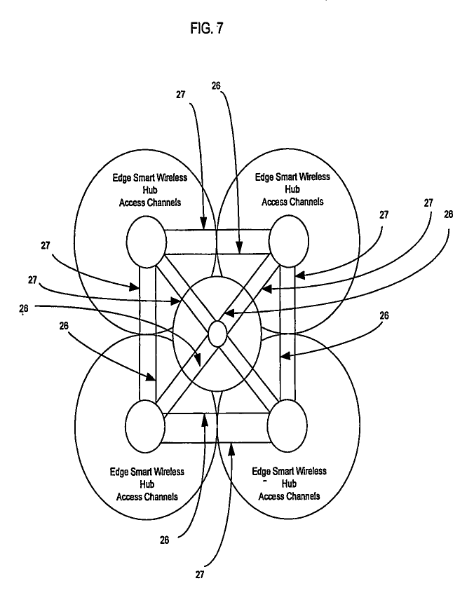

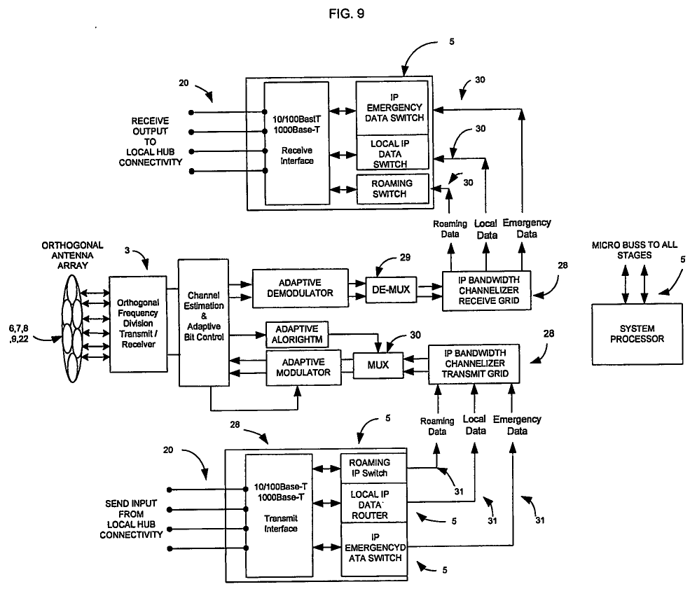

Now turning to FIG. 1 and FIG. 9, the pro-band core radio and omni antenna provides a second optional RF path to properly equipped smart edge wireless hubs positioned remotely to any one of up to six antenna sectors providing coverage to wide area locations and each antenna sector covers a physical space area, typically 60° degrees per antenna and six antennas, as illustrated in FIG. 3, which would cover 360° degree radius, sending RF signal outward, to a range of about one to eight miles, depending upon transmit power settings, type of system transmit signal encoding format applied, physical terrain makeup and variable weather conditions within an area. Referring to FIG. 7, the second RF path transmitted that links each site provides additional bandwidth expansion setting up an alternate channel for special subscriber services that may include, but are not limited to, a hot on channel for subscriber easy access to roaming, emergency community communications and dynamic bandwidth expansion of the primary channel bandwidth beyond the normal payload sized network provided in similar systems. A hot on channel allows real-time access.

A primary RF channel transports normal payload IP data traffic while operating on horizontal polarization with separate assigned frequencies, and while the secondary RF channel operates on vertical polarization being assigned a different frequency; both channels are controlled through the micro controller and payload IP switch located at the pro-band core microwave radiolocation. This extended bandwidth is separated into individual payload nodes, providing part time and full time access for services. The pro-band core microwave radio operating with virtually any number of smart edge wireless hubs provides several unique and separate expansions and use of microwave radio bandwidth to accommodate subscribers as listed in the following table:

| | | | |
|---|---|---|---|
| Subscriber Use | Channel | Path # | Payload |

Primary RF Path

| | | | |
|---|---|---|---|
| IP Traffic | Channel A | Path #1 | IP Data |

Secondary RF Path

| | | | |
|---|---|---|---|
| IP Traffic | Channel A | Path #1 | IP Data |
| Roaming Hot On | Channel B | Path #2 | IP Data |
| Emergency Community | Channel B | Path #2 | IP Data |
| Dynamic Load Control | Channel B | Path #2 | IP Data |

Illustrated in FIG. 7, the above primary and secondary RF channels provide an advantaged method of expanding the systems bandwidth without adding expensive external peripheral equipment for bandwidth control and multiplexing. This aspect of the invention provides an extended bandwidth and service offering to the network user who simply and quickly jumps on and off the smart edge wireless hub at any given site and any time. This will greatly simplify the typical PC user's efforts to link up and tear down a network connection. In FIG. 4, the subscriber user can disconnect or disengage from the data grid area site D and smart edge wireless hub and travel to a second and different data grid site A, and simply and quickly connect at this different smart edge wireless hub site and start communicating as if the device never left the first site D network. This seamless transfer can take place only through shared central data bank storage of subscriber information whereby data can be flagged for hold status as the subscriber disengages at the first location and readdressed the information at the original site placed in hold status and later reappeared at a different data grid network. The smart edge wireless hub software program sends bursting data up-stream to share status information with other microcontrollers and payload IP switch on a continuous basis during all subscriber sessions, including sign-on, sign-off, stop sending and hold/transfer status. The actual software code and data instructions are defined under separate patent references.

Now turning to bandwidth expansion using a secondary channel, this function is achieved with the present invention more economically and essentially with the same antenna systems that support a second RF channel very easily and with limited new expense. Now again turning to FIG. 4 specifically to smart edge wireless hub designated sites B, D are both linked back to the pro-band core microwave radio site 001A. Sites B and D are equipped with a second transmitter/receiver system numbering the total of two antennas that sets up a second antenna path between Site D and Site B in such configuration as to form a triangle RF transmission path between the three sites identified. Each sectional single path of the three paths forming this RF ring operates dual RF paths having vertical and horizontal polarizations applied. Each RF path carries IP packet payloads in the form of primary A RF channel and secondary B channel with B channel content illustrated in FIG. 7, carrying roaming hot on line traffic, emergency community traffic, the dynamic load control channel. In addition, this RF triangle arrangement provides security surveillance and IP data for real time video cameras, security door locks and a highly secured path for activated security coded keys. The triangle RF system transports cipher protected packets of highly classified data and each of these cipher protected packets scrambled in session to form a dual path of data where a data word is sliced and assigned into digital coded words in IP formats and again separated into two data RF path flows, one transmitted on path B and path D to reach site B and the second transmitted from the pro-band core microwave radio is directed to site D by path B. Note that two path hops are required in one leg while only one RF path or hop is required to complete the path from pro-band core microwave radiolocation to site D. The invention of this routing provides digital data transported over paths B to D will arrive at site B ahead by a few milliseconds of data that passes through site D and repeated on to site B requiring two RF hops. The data first arriving at site B carries an assembly and de-assembly code for assembling and taking apart data bits arriving on the delayed channel. The transmitted key is therefore sent the shortest route and a different route than the data packet carrying the actual payload. The supervisory code is never transmitted over the same path with data content that it controls.

Cipher-lopes are electronic secured packets of data that are highly secured through packet-coded keys, assembled in highly secured sealed electronic digital packets of IP data that are coded close, and sent over the above link to highly secure the data content. Should the packed ever be opened during transit, a flip-flop logic circuit will leave a sign of the intrusion and breech of security. The RF path is constructed in physical form to provide full path and system diversity through two RF links. The two data paths reach their secured environment only in an proper protected environment where the two keys match a series of ever changing digital coded word in the form of management instructions and only after being fully exercised and tested with these digital words are these words allowed to be used to de-cipher and assemble the packets of data at the receiving station, demanding duly authorized code to open and detect the content.

Turning once again to FIG. 7, the architecture of a single cluster illustrated in FIG. 2 defines the method used to establish a primary channel and secondary charnel covered above. The cluster illustrated and referenced as FIG. 7 has four edge smart wireless hubs shown as circles around a center cell representing the pro-band core microwave radio, the microcontroller, and payload switch. One cluster when attached by RF to other clusters provides internetworking connectivity and control to multiples of edge smart wireless hubs illustrated in FIG. 4. Referencing FIG. 7 and drawing attention to the connecting outside illustrated lines encircling all four edge smart wireless hubs, these represent the primary channel, and a second inside line paralleling the outside lines is the secondary channel. Note that in FIG. 7 and FIG. 4, all four edge smart wireless hubs are interconnected and communicate to each other by means of establishing the RF path between each multiples of edge smart wireless hub back to the pro-band core microwave radio sites 001A and 002A, each at the center of a cluster. Note that the multiple RF paths are optional for establishing and maintaining a well-secured and seamless infrastructure that is able to support the highest of transmission protection for securing cipher-lopes.

Links from the pro-band core microwave radio-connecting cluster of FIG. 3, and FIG. 7 to other outside clusters are illustrated by the two lines connecting by way of radio path having both horizontal and vertical polarizations. These RF paths are direct point-to-point RF channels on both vertical and horizontal polarizations.

Drawing configurations FIG. 3 and FIG. 7 illustrate the invention and system path configuration that supports transmission of cipher-lope in the form of secured data between multiples of edge smart wireless hubs located in and outside the cluster that is uniquely capable of forming a microwave ring for RF transmission protection in the event that one path is lost due to transmission failure. As a general rule, content and setup/takedown instructions are never sent in the same IP packet and never over the same RF paths. Routing of the Cipher-lope packets is controlled by pro-band core IP switches and micro controller. In routes where the Cipher-lope destination may take it across seamless boundaries from one cluster site to another cluster site as illustrated in FIG. 4, then setup and take down procedures are passed from the originating cluster to the second cluster pro-band core micro controller.

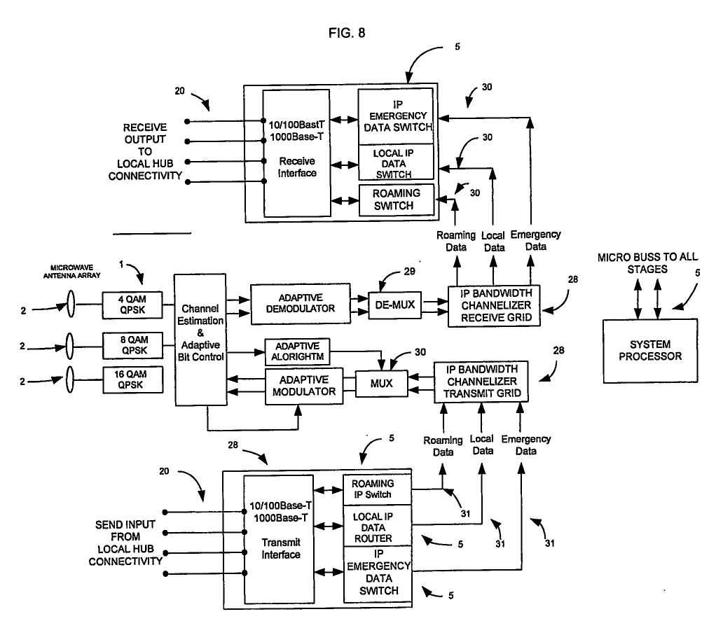

This security level can be utilized for IP security of any sort, outside Cipher-lopes applications. Voice over IP (VoIP) and video digitized content can be provided a higher level of security on the licensed radio band. FIG. 8 and FIG. 9 diagrams show different modulation types used, namely OFDM, QAM and QPSK. All three-modulation types have some advantages and trade-offs. As discussed earlier and referenced in FIG. 6, setting polarizations and throttling transmit power down to an accepted QoS level enhances the overall performance of the network.

Now turning to FIG. 9, the RF microwave transmission system adapts orthogonal frequency division modulation at all edge smart wireless hubs broadcasting RF to achieve frequency reuse efficiency and to provide improved RF reception performance and local loop reliability. OFDM signals are transmitted in a pattern of up to 360° degrees geographical coverage at A, B, C D, and E sites illustrated in FIGS. 3 and 4. Coexistence with other point-to-point RF links is accomplished by using cross-polarization, separating adjacent channel interferences by proper frequency selection, the use of highly directional antennas with high cross-polarization rejection, giving consideration to physical placements of antennas, and using antennas with low side lobes, as well as applying error-correction. To reduce co-channel interference, the system measures transmitted power of each leg by taking measurement samples of each RF receiver level sensitivity and bursting each of these results in the form of packet overhead back to the transmitter end allowing the microcontroller to take action and throttle the transmit power to a level that results in reliable and useable transmission signal quality and is further automatically measured against system preset QoS reference levels.

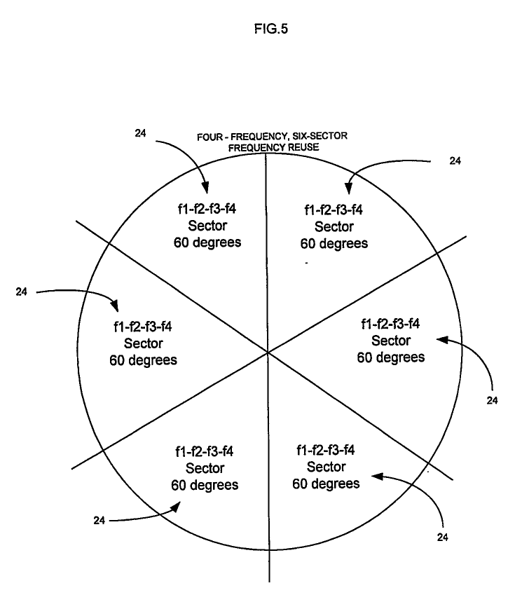

Frequency reuse is employed in each edge smart wireless hub to expand the capacity of each pro-band core microwave cluster. FIG. 5 illustrates a typical four frequency six sector frequency re-use pattern applied to each six sectors and antenna array that cover an geographical area up to 360° degrees diameter further illustrated in FIG. 1.

Turning to FIG. 4 within a cluster, polarization of each sites A, B, C, and D are setup as defined to minimize adjacent transmit frequency interference. The full frequency band is reused for maximum frequency spectrum coverage in each smart edge wireless hub site. The microcontroller detects any RF link loss and will reverse direction so that information flow in these protected links is uninterrupted. The edge smart wireless hubs A, B, C, and D form an outside transmission ring, as well as communicate with the center pro-band core microwave radio, as illustrated in FIG. 4. The pro-band core microwave radio is able to transmit over four paths, namely the A1 path to B1 path and C1 path to D1 path, out to each respective outlying edge smart Wireless Hub, A Hub, B Hub, C Hub and D Hub.

Now turning to FIG. 8 and FIG. 9, the user interface is representative at 20 input to a 10/100 base T copper or SX fiber interface to the transmit input. Note that at 20 the received signal is output to the end user on a LAN and the input from LAN is the transmitted payload.

The IP 28 Ethernet signal passes through the transmit interface to a stage called IP data switch 5, where the packet address headers are detected and read and the IP packet signal routed thru. The common channel is aligned throughout each and every site, thus originating a seamless hot roaming channel, as well as an emergency community channel and dynamic load control channel that operates in each and every outlying smart edge wireless hub. Security of these channels is set up according to the cipher-lope standard of operation, rendering all site bandwidth to be highly secured for both the primary and secondary channels.

As illustrated in FIG. 1, six signals are received by an orthogonal antenna 15 at the smart edge wireless hub 18 and are interfaced 16, 17 into the smart edge wireless hub 18 controlled by the remote micro controller 19 at the remote site. FIG. 1 illustrates the QPSK and QAM transmission path 14 between the antenna 15 at the smart edge wireless hub and the antenna 2 at the pro-band core microwave radio receiver input and transmits 1.

The embodiments of the invention described above provide a licensed microwave radio multi-functional broadband system that includes dynamic central to remote management system having multiple numbers of installed edge smart wireless hubs. The system is capable of selective transmission type QAM, QPSK and orthogonal frequency division multiplexing system for broadcast over point-to-point, point to multipoint and omni-directional antenna arranged in six equal 60° degree arrays.

There is also an intelligent data IP packet measurement system through software dynamically reads and controls Quality of Service [QoS] and throttles power up and power down to meet changing effects of transmission parameters in virtual real time.

The system has receiving remote antennas capable of changing polarization settings to allow frequency reuse, and with programmable receive low noise block (LNB) filters to minimize adjacent RF signal cross talk.

The system's antenna system has a six sector antenna stage, and an antenna that applies QAM and QPSK modulation selection automatically, depending to achieve the desired path distance, bandwidth, and quality of service [QoS].

In one embodiment of the system, the antenna array combines flat panel and parabolic antennas together to serve QAM, QPSK and OFDM RF transmission.

In another embodiment of the system the transmitting antenna system includes a remote smart edge wireless hub capable of receiving and transmitting three formats, QAM, QPSK and OFDM signals in the same mechanical antenna.

In one embodiment of the system, a remote smart edge wireless hub antenna system adjusts polarizations orthogonally to achieve minimum crosstalk and maximum isolation to lower adjacent frequency interferences.

In one embodiment of the system a remote smart edge wireless hub antenna system that transmits and receives RF signals of different path alignment and carrier frequency types to establish two independent RF paths.

In one embodiment of the transmitting and receiving system there is a primary RF channel A linking local and remote smart end wireless hubs for IP data traffic, and a secondary RF channel B linking for user roaming hot-on. There may also be a secondary RF channel B for emergency community channel service and for dynamic load control.

In one embodiment of the invention, there is also a dynamic RE re-routing in ring configuration system that includes a network RF path direction that can be redirected upon failure of the primary RF path or secondary RF path on a seamless basis.

In one embodiment of the invention there is a network RF path sending data over an RF network with data content divided into two or more paths to support cipher-lope highly secured content by sending setup/takedown code in direct path and content in second and longer path.

One embodiment of the invention includes a physical encapsulated packet that contains a header referenced to activate an onboard physical circuit flip/flop control to indicate packet-tampering status.

A further embodiment of the invention includes a secured encapsulated packet management system that reads status at a physical point along the transmission path in virtual real time, and with electrical / physical circuit status.

In another embodiment of the system the pro-band core microwave, microcontroller, and IP switch includes a user time-share of bandwidth on a part time basis on 7×24×365 time having access at any smart edge wireless hub location. There is also provision for a user, or multiple users, to have time-share access to emergency channel use in case of local emergency or local and national disasters.

In a further embodiment of the system the pro-band core microcontroller and IP switch includes a bursting data stream up-link and down link from the smart edge wireless hub to and from the pro-band core microcontroller and IP switch to measure QoS and make system equipment adjustments to outlying equipment power, polarization, switching modulation types for management of pro-band core network.

There may also be a system setup for establishing a data grid around the pro-band core microwave and multiples smart edge wireless hubs that provide exclusive and non-exclusive security services in the form of security surveillance cameras, door/window alarms or other entrance locks and including proximity alarms, remote alarms, temperature controls, fire and water alarms that report to distributed or centrally located points.

In one embodiment the pro-band core microcontroller and IP switch and smart edge wireless hub controller includes an enhanced forward error correction coded algorithm signal monitors IP data performance for errors, dropped packets, noise on transport facilities, as well as capability for the system processors to transfer payload onto a pre-selected alternate route.

There may also be a load balancing control capable of determining when routing IP packets from primary channel are at or near maximum load, and then ensuring that packets are routed over secondary channel for dynamic load control and to add bandwidth.

In a further embodiment of the system the pro-band core microcontroller and IP switch and smart edge wireless hub controller includes a roaming secondary channel dedicated to permanently un-numbered smart edge wireless hubs covering an entire metropolitan area network.

There may also be a secondary channel dedicated to permanently open connectivity for emergency use throughout a metropolitan area network providing a private channel for communicating and sending data in emergency conditions.

In one embodiment of the system two smart edge wireless hubs may operate as a master smart edge wireless hub configured as master controller and a slaved smart edge wireless hub configured as slaved to extend IP service between two locations.

There may also be a master smart edge wireless hub-A location configured as master controller and a slaved smart edge wireless hub-B location, each configured with two antennas that communicate between each smart edge wireless hub A to B and to pro-band core microwave radio, micro controller, and payload switch.

The pro-band core system delivers a variety of one and two-way communication signals carrying multi services of private and public Wi-Fi networks, and digital two-way transmission with internet content, IP video, data and voice [VoIP] packets using IP internet protocol

While the invention has been described with reference to the preferred embodiment thereof, it will be appreciated by those of ordinary skill in the art that various modifications and changes can be made to the structure and functions of the individual parts of the system without departing from the spirit, and scope of the invention as a whole.

### INDUSTRIAL APPLICABILITY

The present invention has industrial applicability to the telecommunications industry. In addition, the present invention is suited to use in the industries of communications service provision, including cellular and data communications. The present invention is also suited for use in the emergency service industry.

1. A multi-function microwave radio system comprising:
one or more data grid elements, each data grid element comprising:
one or more smart edge wireless hubs comprising: hub-radio means for transmission and reception of radio signals; and a hub-micro-controller means for selecting transmission and reception parameters of said hub-radio means; and
a central processing unit comprising: a core-radio means for transmission and reception of microwave signals; an internet packet switching means for dynamically routing one or more information packets to said smart edge wireless hubs; and core-micro-controller means for selecting transmission and reception parameters of said core-radio and of said hub-radio, said core-micro-controller means including a transmission type selection means for automatically selecting to switch said hub-radio means and said core-radio means from transmitting and receiving using a first radio modulation type to transmitting and receiving using a second, different, radio modulation type.

2. The system of claim 1, wherein said core-micro-controller means further includes a packet measurement means for obtaining a quality-of-service measure related to said transmission and reception of said radio signals.

3. The system of claim 1 wherein said first and second radio modulation types are dynamically selected from the group consisting of Quadrature Amplitude Modulation (QAM), Quadrature Phase Shift Keying (QPSK) and Orthogonal Frequency Division Multiplexing (OFDM), responsive to said quality-of-service measure.

4. The system of claim 2, wherein said core-micro-controller means further includes an antenna type selection means for automatically selecting to switch said hub-radio means and said core-radio means from transmitting and receiving using a first antenna type to transmitting and receiving using a second, different, antenna type and wherein said first and second antenna types are selected from the group consisting of an omni antenna and a multiple sector antenna.

5. The system of claim 2, wherein said core-micro-controller means further includes a transmission frequency selection means for selecting a transmission frequency by reference to a centralized or distributed registrar of all frequencies available to all said smart edge hubs.

6. The system of claim 5 wherein said transmission frequency selection means is responsive to said quality of service measurement.

7. The system of claim 2 wherein said core-micro-controller means further includes means for adjusting a transmission power and/or a bandwidth of said core-radio means responsive to said quality-of-service measure.

8. The system of claim 1, wherein said central processing unit further includes means for establishing a primary and a secondary transmission channel over diverse paths.

9. The system of claim 8, wherein said central processing unit further includes means for traffic rerouting responsive to a failure to transmit said information packet.

10. The system of claim 8, wherein said central processing unit further includes means for traffic rerouting responsive a traffic load imbalance.

11. The system of claim 1, wherein said information packets comprise secured, sealed electronic packets.

12. The system of claim 11, wherein said secured, sealed electronic packets comprise header means responsive to packet tampering.

13. A multi-function microwave radio transmission method, comprising the steps of:
providing a central processing unit comprising a core-radio, a core-micro-controller and an internet packet switch;
providing one or more smart edge wireless hubs comprising a hub-radio and a hub-micro-controller;
automatically selecting to switch said core-radio and said hub-radio from transmitting and receiving using a first radio modulation type to transmitting and receiving using a second radio type; and
dynamically routing one or more information packets to said smart edge wireless hubs using said internet packet switch and one or more radio signals transmitted from said core-radio.

14. The method of claim 13, further comprising the step of obtaining a quality-of-service measure related to said transmission and reception of said radio signals using a packet measurement system.

15. The method of claim 14, wherein said first and second radio modulation types are selected from the group consisting of Quadrature Amplitude Modulation (QAM), Quadrature Phase Shift Keying (QPSK) and Orthogonal Frequency Division Multiplexing (OFDM), and wherein said selection is responsive to said quality of service measure.

16. The method of claim 14, further comprising the step of automatically selecting to switch said core-radio and said hub-radio from transmitting and receiving using a first antenna type to transmitting and receiving using a second antenna type and wherein said first and second antenna types are selected from the group consisting of an omni antenna and a multiple sector antenna.

17. The method of claim 14, further comprising selecting a transmission frequency by reference to a centralized or distributed registrar of all frequencies available to all said smart edge hubs.

18. The method of claim 17 wherein said transmission frequency selection is responsive to said quality of service measurement.

19. The method of claim 14 further comprising the step of adjusting a transmission power and/or a bandwidth of said core-radio responsive to said quality-of-service measure.

20. The method of claim 13, further comprising the step of establishing a primary and a secondary transmission channel over diverse paths using said central processing unit.

21. The method of claim 20, further comprising the step of rerouting traffic responsive to a failure to transmit said information packet.

22. The method of claim 20, further comprising the step of rerouting traffic responsive to a traffic load imbalance using said central processing unit.

23. The method of claim 20, wherein said information packets comprise secured, sealed electronic packets.

24. The system of claim 23, wherein said secured, sealed electronic packets comprise headers capable of detecting packet tampering.

25. The system of claim 2 wherein said means for automatically selecting to switch said hub-radio means and said core-radio means from transmitting and receiving using a first radio modulation type to transmitting and receiving using a second, different, radio modulation type is responsive to said quality of service measurement.

26. The method of claim 14 wherein said automatically selecting to switch said core-radio and said hub-radio from transmitting and receiving using a first radio modulation type to transmitting and receiving using a second radio type is responsive to said quality of service measurement.
